(19) United States
(12) Patent Application Publication
(10) Pub. No.: US 2007/0081746 A1
(43) Pub. Date: Apr. 12, 2007

(54) Parallel spacer for a linear guideway

(75) Inventors: Tsung-Jen Chen, Taichung (TW); Scotte Chen, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/245,822

(22) Filed: Oct. 7, 2005

(51) Int. Cl. F16C 19/00

(52) U.S. Cl. 384/51

(57) ABSTRACT

A parallel spacer for a linear guideway comprises a plurality of parting portions, connecting portions and a retaining portion. Each of the parting portions is a thin member disposed between each pair of neighboring rollers. The connecting portions are employed to connect the parting portions and the retaining portion, and the retaining portion is arranged at a side of the respective rollers and located in an axial direction thereof, the retaining is integrally formed with the respective connecting portions and the parting portions.

### BACKGROUND OF THE INVENTION

1. Field of the Invention

The present invention relates to a spacer structure for a linear guideway, the spacer is a unitary structure consisted of a plurality of parting portions, connecting portions and a retaining portion, and is suitable for mass production and can prevent the rollers from skewing and impacting from each other, thus ensuring a smooth operation of the linear guideway.

2. Description of the Prior Arts

With the development of science and technology, and the improvement of the precision feeding system, linear guideway and technology thereof have become a most important part of many precision mechanisms. Various types of linear mechanisms have been and are being widely used in different fields. Although the linear guideway technology is developing fast, still there are some problems of the linear products that need to be improved. Many efforts have been made by the related industry to effectively improve the quality of linear guideway, in particularly, those high precision mechanisms (such as wafer processing equipment and CNC Computer Numeric Control instruments) that need to run stably and silently. Therefore, there are still some blind spots in the existing linear mechanisms that need to be exploited and erased.

The existing linear guideways can generally be divided into three categories:

A. The first type linear guideway as shown in FIG. 1 generally includes a plurality of rollers 10 that are connected by a chain 12. The production of the chain 12 is considered as a core of the mould and comprises the following steps: first, putting the rollers 10 into the male and female moulds, and then ejecting plastic into the moulds. This type of linear guideway (JP Patent No. 3,436,708 or U.S. Pat. No. 6,626,572) has the following disadvantages:

1. The number of rollers 10 is in proportion to the length of the chain 12, if the chain 12 is long, the number of rollers 10 should be relatively large, and the production time is relatively long.

2. Assembling the chain 12 with the rollers 10 is laborsome.

3. The chain 12 uses a plurality of spacers 11 to separate the rollers 10, the spacers 11 each has two concave contact surfaces for contacting with rollers 10 and the diameter of the concave contact surfaces of the spacers 11 is equal to that of the rollers 10. Therefore, the spacers 11 are in full surface contact with the rollers 10, this will lead to a great friction. And a long time of relative slide between the rollers and the spacer will increase the elastic fatigue of the chain.

B. A second type linear guideway (disclosed by U.S. Pat. No. 3,964,802) as shown in FIG. 2 employs a plurality of spacers 13 to separate the rollers 10, each of the spacers 13 includes two retaining portions 131 to be inserted in the rollers 10, and a pair of strip portions 14 arranged between two neighboring rollers 10 for prevention of metal-slide-induced friction therebetween. The respective spacers 13 are alternatively arranged at either end of the respective pairs of rollers 10, that is to say, each of the rollers 10 is provided with a spacer 13. The disadvantages of this type linear guideway as explained as follows:

1. The rollers 10 should be formed at either end thereof with a hole for insertion of the retaining portions 131 of the spacers 13, this will not increase the processing cost but also weaken the strength of the rollers 10.

2. As compared with to the spacer with concave contact surface, the spacer 13 of the second type linear guideway occupies much more spaces of the linear gudieway, such that the number of rollers 10 in a given length of linear guideway will be reduced, thus adversely affecting the load capacity and the rigidity of the linear guideway.

3. The spacers 13 in a line guideway cannot be made at one time but need to be assembled separately, therefore, the assembly is really time consuming.

C. A third type linear guideway (disclosed by U.S. Pat. No. 6,390,678 and JP patent No. 11-351254) as shown in FIG. 3 comprises a conical connecting portion 15 connected between the respective rollers 10 and located along the radial direction of the rollers 10. Each of the rollers 10 is equally divided into halves, and the disadvantages of this type linear guideway as explained as follows:

1. since the connecting portion 15 is located along the radial direction of the rollers 10, and the radial direction of the roller is the most import loading direction of the linear guideway, it will substantially reduce the contact surface between the rollers and the slide groove of the slide block, and will largely weaken the load capacity and the rigidity of the linear guideway.

2. In the rolling passage, the conical connecting portion 15 will cause inference to the rolling passage because of weight, thus causing slide friction and affecting the smooth operation of the linear guideway.

The present invention has arisen to mitigate and/or obviate the afore-described disadvantages.

### SUMMARY OF THE INVENTION

The primary objective of the present invention is to provide a parallel spacer for a linear guideway that is a unitary structure suitable for mass production and comprises a plurality of parting portions, connecting portions and a retaining portion. Each of the parting portions is a thin member having a length shorter than the rollers, and the connecting portions are designed to connect the respective pairs of parting portions in a single edge contact fashion.

The secondary objective of the present invention is to provide a parallel spacer for a linear guideway that can operate smoothly, wherein the retaining portion is arranged at a side of the respective rollers and is located in the axial direction thereof, and the height of the retaining is less than that of the groove in the rolling passage of the linear system.

The third objective of the present invention is to provide a parallel spacer for a linear guideway, wherein a Gothic arch-style concave contact surface is formed on either side of the respective parting portions for contacting a surface of the respective rollers. This structural design can prevent the rollers from skewing, skipping, friction and impacting, thus substantially reducing the noise caused thereby.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 shows a first type of conventional spacer for a linear guideway;

FIG. 2 shows a second type of conventional spacer for a linear guideway;

FIG. 3 shows a third type of conventional spacer for a linear guideway;

FIG. 4 is an assembly view of a parallel spacer for a linear guideway in accordance with a preferred embodiment of the present invention;

FIG. 5 is an enlarged cross sectional view of a part of the parallel spacer for the linear guideway in accordance with the preferred embodiment of the present invention;

FIG. 6 is an operational view of the parallel spacer for the linear guideway in accordance with the preferred embodiment of the present invention;

FIG. 7 is a cross sectional view of showing the rolling passage of the linear guideway in accordance with the preferred embodiment of the present invention.

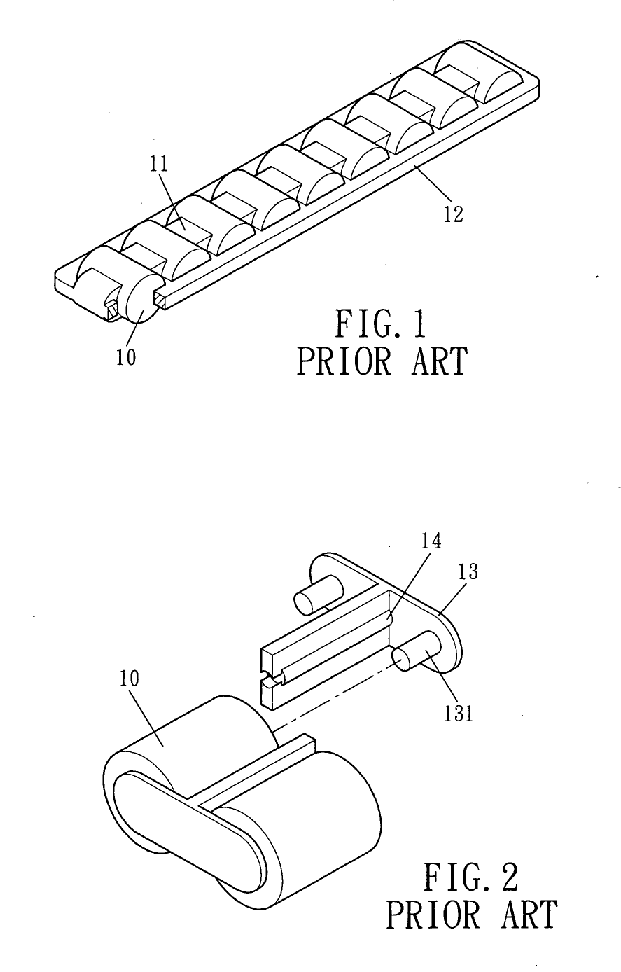

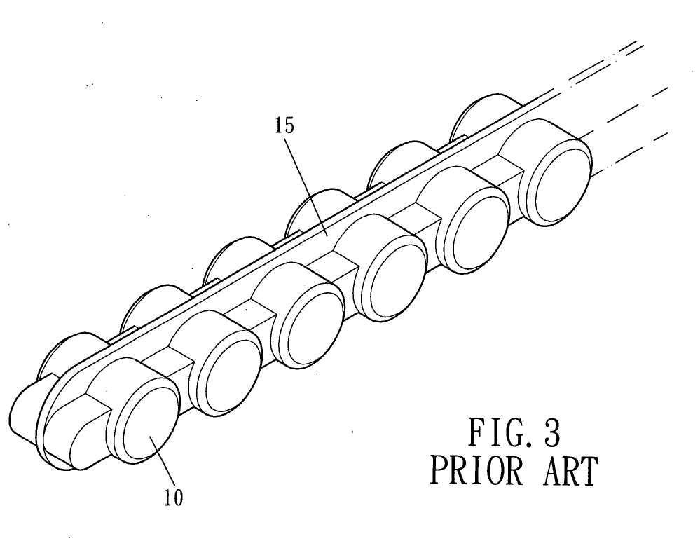

### DETAILED DESCRIPTION OF THE PREFERRED EMBODIMENT

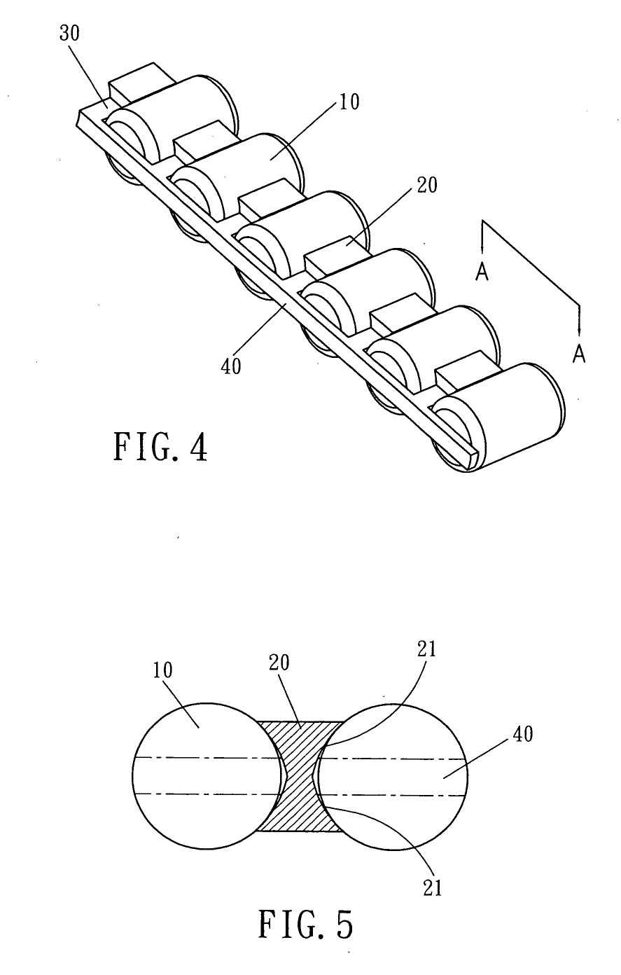

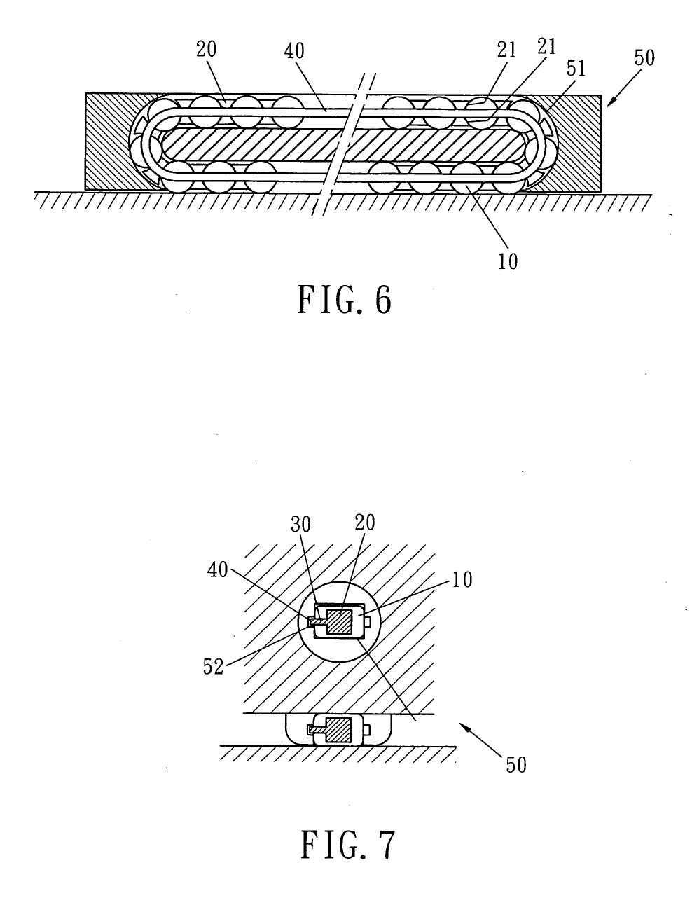

Referring to FIGS. 4-7, a parallel spacer for a linear guideway in accordance with a preferred embodiment of the present invention is designed to move in a rolling passage 51 of the linear system 50 and to engage the groove 52 in the rolling passage 51. The parallel spacer comprises a plurality of parting portions 20, connecting portions 30 and a retaining portion 40.

Each of the parting portions 20 is disposed between each pair of neighboring rollers 10 and is a thin member whose length is shorter than that of the rollers 10. On either side of the respective parting portions 20 is formed a Gothic arch-style concave contact surface 21 for contacting the surface of the rollers 10.

The connecting portions 30 are designed to connect each pair of neighboring parting portions 20 in a single edge contact fashion. The connecting portions 30 and the parting portions 20 are integrally formed, and the height of the connecting portions 30 is less than that of the groove 52 in the rolling passage 51 of the linear system 50.

The retaining portion 40 is arranged at a side of the respective rollers 10 and is located in the axial direction thereof. The retaining 40 is integrally formed with the respective connecting portions 30, the height of the retaining 40 is less than that of the groove 52 in the rolling passage 51 of the linear system 50.

For a better understanding of the present invention, its operation and function, references should be made particularly to FIGS. 5, 6 and 7. As mentioned above, each of the parting portions 20 is a thin member having a length shorter than that of the rollers 10, and on either side of the respective parting portions 20 is formed a Gothic arch-style concave contact surface 21 for contacting the surface of the rollers 10. The Gothic arch-style concave contact surface 21 is only partially in contact with the rollers 10, making the operation of the linear guideway smoother.

With reference to FIG. 7, the connecting portions 30 are designed to connect the respective pairs of parting portions 20 in a single edge contact fashion, and the retaining portion 40 acts as a bridge between the respective connecting portions 30 and the parting portions 20. Since the retaining portion 40 makes the rollers 10 arranged in parallel to each other, the linear guideway will move more smoothly when moving in the return path.

Furthermore, since the height of the retaining portion 40 and that of the connecting portions 30 are minor than that of the groove 52 of the rolling passage 51, it is less likely to cause interference between the groove 52 and the retaining portion 40.

The device of the present invention can be integrally formed and is suitable for mass production, since the connecting portions 30 are integrally formed with the parting portions 20 and the retaining portion 40. In addition, the parting portions 20, the connecting portions 30 and the retaining portion 40 are made of a material having certain flexibility, thus preventing friction and impact between the rollers 10 while reducing the noise generated thereby.

The connecting portions 30 are employed to maintain the position of the retaining portion 40 relative to the respective parting portions 20, thus preventing the slide-induced interference of rollers 10 with the rolling passage 51, and further preventing distortion or fall-off of the parting portions 20.

The connecting portions 30 are arranged at a lateral side of the rollers 10 without reducing the contact surface of the rollers 10 relative to the slide block and without affecting the load capacity and the rigidity of the linear guideway. The connecting portions 30 can shift slightly at the instant the rollers 10 impact the connecting portions 30, thus alleviating the elastic fatigue of the parting portions 20. Similarly, the retaining portion 40 also acts as a buffer between the connecting portions 30 and the parting portions 20, so as to prevent the slide friction between the parting portions 20 and the rolling passage 51.

In general, the parting portions 20, the connecting portions 30 and the retaining potion 40 have the following advantages:

1. Forcing the rollers to be arranged evenly and preventing the rollers from skewing and skipping, thus ensuring the smooth operation of the linear guideway.

2. Preventing friction and impact between two neighboring rollers, thus substantially reducing the noise caused thereby.

3. The device of the present invention is integrally formed by plastic molding, and this method facilitates quick mass production of the linear guideway.

While we have shown and described various embodiments in accordance with the present invention, it should be clear to those skilled in the art that further embodiments may be made without departing from the scope of the present invention.

What is claimed is:

1. A parallel spacer for a linear guideway comprising a plurality of parting portions, connecting portions and a retaining portion; and wherein
each of the parting portions is a thin member disposed between each pair of neighboring rollers;
the connecting portions are employed to connect the parting portions to the retaining portion; and
the retaining portion is arranged at a side of the respective rollers and located in an axial direction thereof, the retaining is integrally formed with the respective connecting portions and the parting portions.

2. The parallel spacer for a linear guideway as claimed in claim 1, wherein a Gothic arch-style concave contact surface is formed on either side of the respective parting portions for contacting a surface of the respective rollers.

3. The parallel spacer for a linear guideway as claimed in claim 1, wherein the parallel spacer is designed to move within a rolling passage of a linear system and to engage a groove of the rolling passage, a height of the respective connecting portion and the retaining portion are minor than that of the groove of the rolling passage.
